(19) United States
(12) Patent Application Publication
(10) Pub. No.: US 2025/0388181 A1
(43) Pub. Date: Dec. 25, 2025

(54) A Vehicle with a Sensor Unit for Environmental Perception

(71) Applicant: AGCO International GmbH, Neuhausen (CH)

(72) Inventors: Fernando Benjamin Fernandez Guzman, Marktoberdorf (DE); Oliver Kaufmann, Marktoberdorf (DE); Christian Roberto Kelber, Marktoberdorf (DE)

(21) Appl. No.: 18/881,425

(22) PCT Filed: Jun. 19, 2023
(86) PCT No.: PCT/IB2023/056320

§ 371 Date: Jan. 6, 2025

(30) Foreign Application Priority Data
Jul. 15, 2022 (GB) 2210395.6

(51) Int. Cl. B60R 16/023; B60R 1/06; B60R 1/12; B60T 7/12; G01S 19/35

(52) U.S. Cl. CPC B60R 16/0231; B60R 1/06; B60R 1/12; B60T 7/12; G01S 19/35; B60R 2001/1223

(57) ABSTRACT

A vehicle includes a sensor unit for environmental perception and a control unit. The sensor unit includes a first position adjustable sensor providing a first view of an environment and a second position adjustable sensor providing a second view of the environment. The control unit is configured to provide a surround view of the environment by composing the first view and the second view, to detect a disturbance in the surround view and to adjust the position of the first or the second position adjustable sensor for reducing the disturbance in the surround view. Related method is also disclosed.

### FIELD

The present disclosure relates generally to a vehicle equipped with a sensor unit for environmental perception.

### BACKGROUND

A safe operation of vehicles, especially of unmanned vehicles, for avoiding collisions or accidents requires an even more intensive usage of sensor systems to capture the environment around the vehicle for detecting objects or obstacles in the close vicinity of the vehicle. Applicable sensor systems for this use case are typically sensor units for environmental perception. A sensor unit for environmental perception may comprise at least one sensor to capture the environment around a vehicle and to generate a surround view of the environment around the vehicle. The surround view may be analyzed by computer electronics. Based on the captured data, types of obstacles may be identified (e.g. living or non-living objects), distances between the vehicle and the objects may be determined and trajectories of moving objects may be estimated to determine an automatic reaction of the vehicle in respect of the object and its behavior, e. g. to execute an emergency braking.

European patent application EP 3 272 586 A1, “Work vehicle”, ”published Jan. 24, 2018, discloses an agricultural vehicle equipped with four cameras. Each camera is oriented in a different direction and captures the environment next to the vehicle. Based on the captured images of the four cameras, an overhead image showing a surround view around the vehicle may be generated.

German patent DE 10 2018 205 694 B3, “System und Verfahren zum Erfassen eines Umfelds eines Fahrzeugs, Fahrzeug mit einem System zur Umfelderfassung und Verfahren zum Notbremsen eines Fahrzeugs,” granted Jun. 27, 2019, discloses a vehicle with at least three cameras of which one is directed to the forward direction of the vehicle, one to the left direction and one to the right direction. The cameras are used to capture the environment around the vehicle. The vehicle comprises an additional camera to be activated if a trailer is connected to the vehicle probably disturbing the field of view of one of the at least three cameras used to capture the environment around the vehicle. I. e., the additional camera may compensate the camera having the disturbed field of view.

### BRIEF SUMMARY

It is an objective to provide a sensor unit for environmental perception being configured to reduce or resolve a disturbance in the surround view of the sensor unit by usage of the sensors provided for capturing the environment around the vehicle without the usage of an additional sensor.

According to an aspect of the invention there is provided a vehicle with a sensor unit for environmental perception. The sensor unit comprises a first position adjustable sensor providing a first view of an environment, and a second position adjustable sensor providing a second view of the environment. The vehicle further comprises a control unit. The control unit is configured to provide a surround view of the environment by composing the first view and the second view, to detect a disturbance in the surround view, and to adjust the position of the first or the second position adjustable sensor for reducing the disturbance in the surround view.

The vehicle may be of any type such as an agricultural vehicle (tractor, harvester, combine, etc.), a construction vehicle or any road vehicle. The vehicle may have autonomous driving functions in addition or alternatively to an operator control for manual driving. The first and the second position adjustable sensors may be of any type applicable for environmental perception such as for example camera, LIDAR, radar, ultrasonic sensor, etc. or any combination thereof. The control unit may provide the surround view by stitching the first view and the second view to a consistent view (i. e. a closed view of 360° around the vehicle).

Since the ranges of the first and second position adjustable sensors are limited to their corresponding views (first and second view) a disturbance within the surround view may prevent a reliable detection of an object in the environment around the vehicle. But if the control unit detects a disturbance in the surround view the control unit may adapt the first and second view of the position adjustable sensors by adjusting the positions of the position adjustable sensors so that the disturbance is resolved or at least reduced for a safe detection of any objects in the vicinity of the vehicle. I. e. the surround view can be adapted by the control unit in case of a detected disturbance without the need of an additional sensor.

The first view and the second view may overlap in a first overlapping area at a front side of the vehicle or in a second overlapping area at a rear side of the vehicle.

The first and the second overlapping areas may be used to improve the resolution of the captured data of the position adjustable sensors at the front or the rear side of the vehicle. The improved captured data may be used for more enhanced analysis of objects in the overlapping areas, e. g. to calculate an angle between the vehicle and an attachment (e. g. an implement) connected to the vehicle at the front or rear side of the vehicle. The first view and the second view may overlap in either the first or the second overlapping area or in both overlapping areas simultaneously.

The control unit may be configured to detect that the disturbance is caused by a component of the vehicle.

The component may be any part or attachment of the vehicle as for example the wheels or a detachable implement (e. g. trailer, plough, mower, front-loader, back-loader, etc.) attached to the vehicle. A disturbance may arise if the configuration of the vehicle is changed, for example if an attachment is connected to the vehicle or if wheels of greater dimensions (e. g. dual tires) are mounted to the vehicle.

The control unit may be configured to distinguish the disturbance caused by the component of the vehicle from a disturbance caused by an object being different from the component of the vehicle.

The control unit may recognize all components of the vehicle based on a database stored in a memory of the control unit. For example, the database may comprise image information of each component of the vehicle to be compared by the captured data of the position adjustable sensors for identifying the components in the surround view. Other objects not being identifiable by the control unit may be recognized as objects being different from a component of the vehicle. These objects may be obstacles. Hence, the control unit may determine if a disturbance is caused by a component of the vehicle or by another object. If the disturbance is caused by a component of the vehicle the position of the position adjustable sensors may be adapted otherwise not.

The disturbance may be an interruption of the surround view.

The disturbance may be a blind spot in the surround view.

The interruption of the surround view or the blind spot in the surround view may be caused by a component of the vehicle. For example, an interruption may be detected if the component protrudes out of the first or second view of one of the position adjustable sensors so that the component may collide against an obstacle being also out of view in an undetectable manner. In case of a blind spot the component may hide an obstacle so that the obstacle is undetectable within the surround view. Generally speaking, the disturbance may be any restriction of the surround view caused by any component of the vehicle preventing a reliable detection of an object in the surround view being different to the component of the vehicle and causing a potential collision with the vehicle.

The first and the second position adjustable sensors may be laterally moveable in respect of a longitudinal axis of the vehicle.

The position adjustable sensors may comprise an actuator such as an electric motor to move the position adjustable sensors. The actuator may be controlled by the control unit to provide an exact position adjustment of the first and the second position adjustable sensors. So, the control unit may control the distances the first and the second position adjustable sensors protrude from the vehicle. The actuator may comprise a length variable extension such as a telescopic device to extract the position adjustable sensors away from the vehicle or to retract the position adjustable sensors closer to the vehicle. The position adjustable sensors may be axially or rotatably moveable in at least one additional degree of freedom as for example in a vertical direction, a longitudinal direction or about a longitudinal, lateral or vertical rotation axis. For each degree of freedom the position adjustable sensors may comprise an additional actuator controllable by the control unit. Thus, the position and the orientation of the position adjustable sensors may be adjustable.

The control unit may be configured to move the first or the second position adjustable sensor from a closer position to a position more distant from the longitudinal axis until the disturbance is resolved.

If one of the position adjustable sensors is positioned too close to the longitudinal axis the control unit may detect a disturbance in the surround view caused by a vehicle component. Then, the control unit may move the corresponding position adjustable sensor away from the longitudinal axis in at least a lateral direction until a reliable detection of an object in the surround view being different to the component of the vehicle and causing a potential collision with the vehicle is possible again. While moving the corresponding position adjustable sensor from the closer position to a more distant position the disturbance is more and more reduced. The control unit may continue moving the corresponding position adjustable sensor until the control unit detects that the disturbance is resolved, i. e. that the surround view is free of any interruption or any blind spot caused by a vehicle component. Then, the corresponding position adjustable sensor is positioned at an adjusted position at which the disturbance is completely reduced (resolved).

The control unit may be configured to move the first or the second position adjustable sensor from a distant position to a position closer to the longitudinal axis of the vehicle wherein the surround view is free of an interruption or a blind spot when the first or the second position adjustable sensor is positioned at the closer position.

The dimensions of the vehicle may be reduced for example if an attachment is detached from the vehicle. Then, the position adjustable sensors may be moved closer to the longitudinal axis to increase the first or the second overlapping areas. The positions of the position adjustable sensors may be adjusted as long as a reliable detection of an object in the surround view being different to the component of the vehicle and causing a potential collision with the vehicle is possible. I. e., the position adjustable sensors may be retracted towards the longitudinal axis as long as an interruption of the surround view or a blind spot in the surround view is not present.

The vehicle may also comprise at least one marker. The marker may be detectable by at least one of the first and the second position adjustable sensor when positioned at the distant position and when positioned at the closer position.

The at least one marker may be used to calibrate the first or the second position adjustable sensor. The marker may be any tag such as a distinctive corner or edge of the bodywork of the vehicle. The marker may alternatively be a code or pattern such as a QR-code or a bar code. The code may comprise additional information such as an identifier and the exact position of the marker readable out by the first or the second position adjustable sensor. The marker may be attached on a hood of the vehicle. At least two markers may be assigned to each position adjustable sensor. The position of each marker may be stored in a memory of the control unit. Since a position adjustable sensor may detect an assigned marker from the close and from the distant position a calibration procedure can be performed from both positions.

The vehicle may also comprise a first side mirror attached to the vehicle by a first mount and a second side mirror attached to the vehicle by a second mount wherein the first position adjustable sensor is attached to the first side mirror or the first mount and the second position adjustable sensor is attached to the second side mirror or the second mount.

The vehicle may comprise a cabin and the first and second side mirror may be attached to the cabin by the corresponding mounts. The length variable extension (e. g. a telescopic device) of a position adjustable sensor may be attached to a corresponding side mirror or its mount wherein the point of the attachment may define the retracted (close) position of the position adjustable sensor (in contrast to the distant position when the position adjustable sensor is extracted).

The first mount or the second mount may be extendible.

Thus, the positions of the position adjustable sensors may be adjusted in combination with an adjustment of the corresponding side mirror. The first mount or the second mount may also comprise a length variable extension such as a telescopic device. The first mount or the second mount may be extendible in a direction laterally in respect of the longitudinal axis of the vehicle.

Alternatively, the first and the second position adjustable sensors may be mounted on other components of the vehicle. For example, the position adjustable sensors may be attached to the cabin or a pillar of the cabin. The position adjustable sensors may be attached to a utility element installation system as disclosed in GB patent application no. 2200935.1, “Mounting of utility elements to utility vehicle”, filed on Jan. 25, 2022, which is hereby incorporated by reference in its entirety. The position adjustable sensors may be attached to a roof of the vehicle. The position adjustable sensors may be mounted on a sensor assembly as disclosed in international patent application no. PCT/IB2022/055782, “A Sensor Assembly for a Work Vehicle”, filed on Jun. 22, 2022, which is hereby incorporated by reference in its entirety.

The first or the second position adjustable sensor may comprise a GNSS receiver.

The GNSS receiver may be used to determine the position of the first or the second position adjustable sensor based on global position satellites signals (GPS, Galileo, etc.). The received position signals may be transferred to the control unit to determine the position of the position adjustable sensors and to determine the distances of the position adjustable sensors protruding from the vehicle.

Another aspect includes a method of calibrating a sensor unit of a vehicle for environmental perception. The method may be a computer-implemented method. The control unit may also be configured to carry out this method.

The method for calibrating a sensor unit of a vehicle for environmental perception comprising a first position adjustable sensor to provide a first view of an environment and a second position adjustable sensor to provide a second view of the environment for providing a surround view of the environment by composing the first view and the second view comprises the steps of moving the first position adjustable sensor in a first direction until at least a part of a component of the vehicle is out of the first view of the environment, moving the second position adjustable sensor in a second direction until at least a part of the vehicle is out of the second view of the environment, moving the first position adjustable sensor in a direction different to the first direction and moving the second position adjustable sensor in a direction different to the second direction until at least one marker of the vehicle is detectable by the first or the second position adjustable sensor.

The movement in the first direction may be a movement in a lateral direction in respect of the longitudinal axis of the vehicle or may be a rotational movement about a vertical axis of the first position adjustable sensor or a combination of both. Analogously, the movement in the second direction may be a movement in a lateral direction in respect of the longitudinal axis of the vehicle or may be a rotational movement about a vertical axis of the second position adjustable sensor or a combination of both. The control unit may stop moving the first position adjustable sensor in a direction different to the first direction if at least two markers assigned to the first position adjustable sensor are covered by the first view. Analogously, the control unit may stop moving the second position adjustable sensor in a direction different to the second direction if at least two markers assigned to the second position adjustable sensor are covered by the second view.

The method for calibrating a sensor unit may also comprise the step of moving the first position adjustable sensor in a direction different to the first direction and moving the second position adjustable sensor in a direction different to the second direction until all components of the vehicle are covered by the surround view.

The components may comprise any parts of the vehicle such as wheels or the hood as well as any detachable attachments such as an (agricultural) implement.

The method for calibrating a sensor unit may also comprise the step of determining the positions of the first and second position adjustable sensor by usage of triangulation.

The method for calibrating a sensor unit may also comprise the step of determining the orientations of the first and second position adjustable sensor by usage of triangulation. The triangulation for determining the position and/or the orientation of the first (or second) position adjustable sensor may be based on the positions of the two markers assigned to the first (or second) position adjustable sensor and the position of a predefined reference point of the vehicle. The position of the predefined reference point may be stored in the memory of the control unit and may be located anywhere at the vehicle, for example on the cabin or on a rear axle of the vehicle.

The method for calibrating a sensor unit may also comprise the step of braking the vehicle until at least one marker of the vehicle is detectable by the first or the second position adjustable sensor or until all components of the vehicle are covered by the surround view.

Thus, the vehicle may be stopped as along as the calibration process is ongoing to enhance a safe operation of the vehicle and to ensure a safe detection of obstacles being in the vicinity of the vehicle before a potential collision may occur.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Several aspects of the invention will now be described, by way of example only, with reference to the accompanying drawings, in which:

FIG. 1 illustrates a schematic view of a vehicle comprising a sensor unit for environmental perception;

FIG. 2 is a simplified view of a control unit of the vehicle shown in FIG. 1;

FIG. 3 illustrates a simplified top view of the vehicle shown in FIG. 1;

FIG. 4 illustrates a simplified top view of the vehicle shown in FIG. 1 equipped with an attachment;

FIG. 5 illustrates a simplified top view of the vehicle shown in FIG. 1 equipped with dual tires;

FIG. 6 illustrates a simplified top view of the vehicle shown in FIG. 1 equipped with dual tires and an attachment;

FIG. 7 illustrates a flow diagram for a method to calibrate a sensor unit for environmental perception.

FIG. 8 illustrates an aspect of the subject matter in accordance with one embodiment.

### DETAILED DESCRIPTION

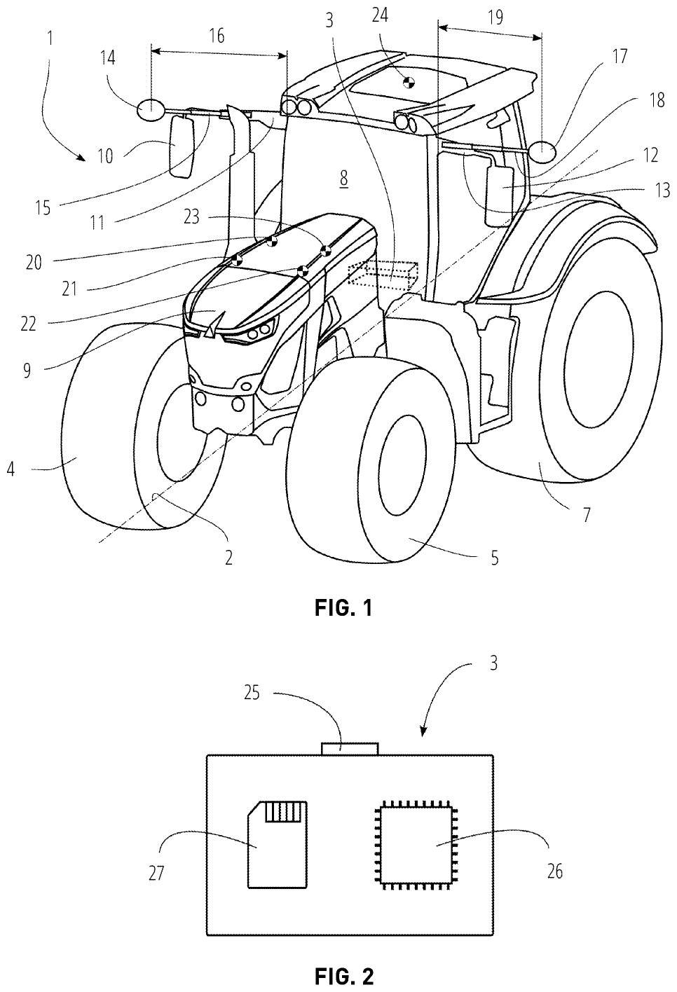

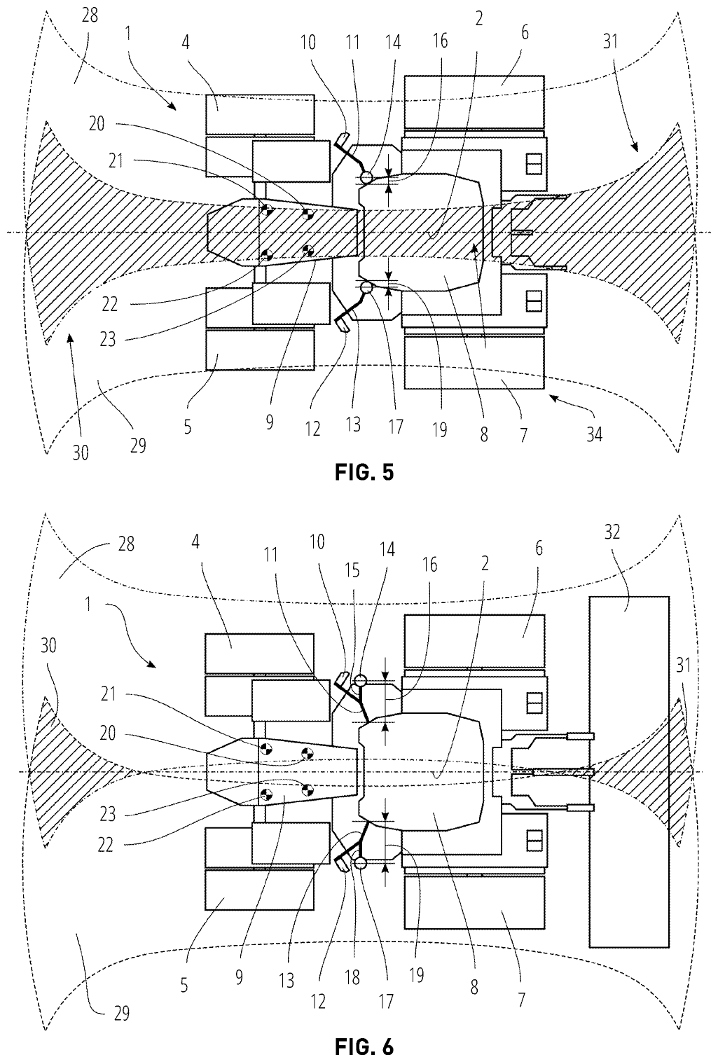

FIG. 1 shows a vehicle 1 by way of example in terms of an agricultural vehicle such as a tractor. The vehicle 1 may be of any other type such as a construction vehicle. A longitudinal axis 2 of the vehicle 1 defines the longitudinal orientation of the vehicle 1. The vehicle 1 comprises a control unit 3, front wheels 4 and 5, rear wheels 6 and 7, a cabin 8, a hood 9, a right side mirror 10 and a left side mirror 12. Vehicle 1 is configurable in different ways. The front and rear wheels 4 to 8 may be configured as single tires as shown in FIG. 1, FIG. 3 and FIG. 4 or as dual tires as shown in FIG. 5 and FIG. 6. The vehicle 1 may also be equipped with a detachable attachment 32 as shown in FIG. 4 and FIG. 6. The right side mirror 10 is attached to the cabin 8 by a mount 11. The left side mirror 12 is attached to the cabin 8 by a mount 13.

Vehicle 1 also comprises a sensor unit with a first position adjustable sensor 14 and a second position adjustable sensor 17. The first position adjustable sensor 14 is connected to the mount 11 of the right side mirror 10 by an extension 15. The second position adjustable sensor 17 is connected to the mount 13 of the left side mirror 12 by an extension 18. The first position adjustable sensor 14 is spaced apart from the cabin 8 by a distance 16 and the second position adjustable sensor 17 is spaced apart from the cabin 8 by a distance 19. The distances 16 and 19 of both position adjustable sensors 14 and 17 are individually adjustable by adjusting the length of the corresponding extensions 15 and 18. Each extension 15 and 18 comprises an actuator controlled by the control unit 3 to extract the position adjustable sensors 14 and 17 away from the cabin 8 or to retract the position adjustable sensors 14 and 17 closer to the cabin 8. Thereby the position adjustable sensors 14 and 17 are moved laterally in respect of the longitudinal axis 2. For example, the extensions 15 and 18 may be configured as telescopic devices. Optionally, the mount 11 of the right side mirror 10 and the mount 13 of the left side mirror 12 are adjustable to adapt the distance 16 of the first position adjustable sensor 14 and the distance 19 of the second position adjustable sensor 17.

Next to the lateral adjustment, the position adjustable sensors 14 and 17 may comprise additional actuators to adjust an orientation of the position adjustable sensors 14 and 17, e. g. a rotation angle about a lateral and/or a vertical axis in respect of the longitudinal axis 2.

The position adjustable sensors 14 and 17 can capture the environment around the vehicle 1 and generate an image thereof. The position adjustable sensors 14 and 17 may be of any type of sensor applicable to generate an image of the environment such as a (stereoscopic) camera, radar, LIDAR, ultrasonic sensor, etc.

For calibrating the position adjustable sensors 14 and 17 the vehicle 1 comprises at least two markers 20 to 23 at defined positions. These positions may be stored as parameters in the memory 27 of the control unit 3. The markers 20 to 23 may be defined and distinctive edges of the vehicle's bodywork detectable by the position adjustable sensors 14 or 17. Alternatively, the markers 20 to 23 may be any tags detectable by the position adjustable sensors 14 or 17 such as for example a bar code or a QR-code. The code may comprise additional data, such as the number and/or the position of the corresponding marker to be gathered by the control unit 3 for the calibration process. Two of the at least two markers 20 to 23 are assigned to the first position adjustable sensor 14 and may be located at any position of the vehicle 1 that is detectable by the first position adjustable sensor 14. Analogously, two of the at least two markers 20 to 23 are assigned to the second position adjustable sensor 17 and may be located at any position of the vehicle 1 that is detectable by the second position adjustable sensor 17. For example, the vehicle 1 comprises markers 20 and 21 detectable by the first position adjustable sensor 14 and markers 22 and 23 detectable by the second position adjustable sensor 17. Each of the at least two markers 20 to 23 may be detectable by the first or the second position adjustable sensor 14 or 17 irrespective if the position adjustable sensor is retracted or extracted.

Additionally, the vehicle 1 comprises also a reference point 24 for the calibration process. The reference point 24 may be located anywhere in the vehicle 1, for example on top of the cabin 8 or at the rear axle of the vehicle 1. The position of the reference point 24 is stored as a parameter in the memory 27 of the control unit 3. Based on this reference point 24 and the positions of the at least two markers 20 to 23 assigned to each position adjustable sensor 14 and 17 the control unit 3 may determine the position of the first and the second position adjustable sensor 14 and 17 by means of triangulation.

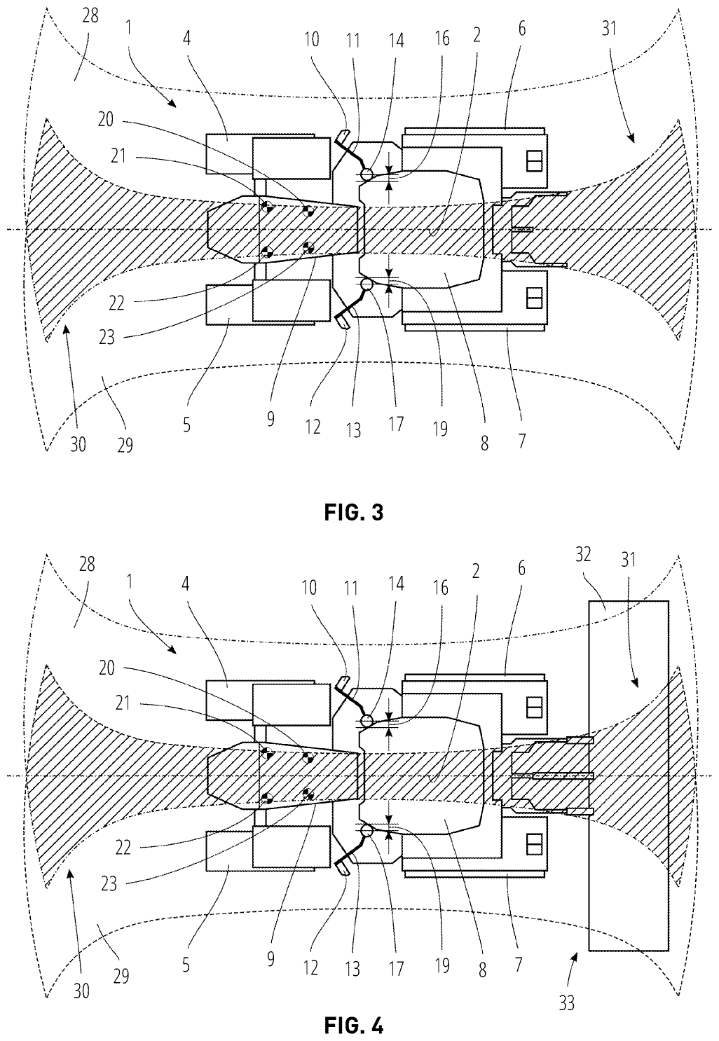

FIG. 2 shows the control unit 3 comprising an interface 25, a controller 26 and a memory 27. The control unit 3 may receive and send signals or data via the interface 25. The interface 25 may be a wireless interface or a connector. The controller 26 may store the data or signals received by the control unit 3 in the memory 27. The memory 27 may contain additional data or executable computer program products, for example in terms of a computer-implemented method, that may be retrieved, processed or carried out by the controller 26. Data or signals resulting from the processing of data or signals or from the execution of a computer program product may be stored to the memory 27 or sent to the interface 25 by the controller 26. The control unit 3 is integrated in the vehicle 1 and connected with the first and second position adjustable sensors 14 and 17.

FIG. 3 shows the vehicle 1 of FIG. 1 in a schematic top view with the first and second position adjustable sensors 14 and 17 retracted to the cabin 8. FIG. 3 shows also a first view 28 of an environment provided by the first position adjustable sensor 14 and a second view 29 of the environment provided by the second position adjustable sensor 17. The first and second view 28 and 29 are transmitted to and received by the control unit 3. The control unit 3 processes the first and second view 28 and 29 of the environment and generates a surround view of the environment by composing the first view 28 and the second view 29. The surround view covers the vehicle 1 completely. Thus, any objects other than the vehicle 1 detected within the surround view may be recognized by the control unit 3 as obstacles. In case of a recognized obstacle the control unit 3 may initiate an appropriate measure to avoid a collision between the vehicle 1 and the obstacle such as automatically braking the vehicle 1.

The first view 28 and the second view 29 overlap each other along the longitudinal axis 2. The overlapping area may comprise two distinct areas: A first overlapping area 30 at a front side of the vehicle 1 and a second overlapping area 31 at a rear side of the vehicle 1. The markers 20 and 21 assigned to the first position adjustable sensor 14 are within the first view 28 and thus detectable by the first position adjustable sensor 14. The markers 22 and 23 assigned to the second position adjustable sensor 17 are within the second view 29 and thus detectable by the second position adjustable sensor 17.

FIG. 4 shows the vehicle 1 equipped with a detachable attachment 32. The attachment 32 may be an agricultural implement such as a mower or a plough and may be connected with the vehicle 1 by means of a 3-point hitch. In contrast to the vehicle 1 the attachment 32 is covered partly only by the surround view. I. e. a part of the attachment 32 is out of the first view 28 and/or the second view 29 which is detected by the control unit 3 as a disturbance 33.

FIG. 5 shows the vehicle 1 equipped with wheels 4 to 7 configured as dual tires instead of single tires. Due to the greater dimensions of dual tires the wheels 4 to 7 are covered partly only by the surround view. I. e. parts of the wheels 4 to 7 are out of the first view 28 and/or the second view 29 which are detected by the control unit 3 as a disturbance 34.

The disturbance 33 or 34 may be a blind spot or an interruption of the surround view of the environment around the vehicle 1 caused by a component the vehicle 1 is equipped with. Since FIG. 4 and FIG. 5 are examples only the surround view may be interrupted optionally by other components of the vehicle 1.

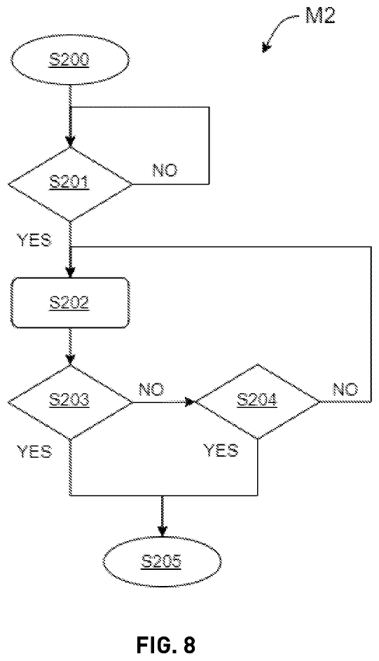

The disturbance 33 or 34 may be (completely) reduced or resolved by the control unit configured for carrying out a method M2 as shown in the flow diagram of FIG. 8. The method M2 may be a computer-implemented method stored as a computer program product in the memory 27 of the control unit 3. The method M2 may be carried out by the controller 26 of the control unit 3. The method is described by way of example of several steps without any restriction in respect of that steps. I. e. the number or the order of steps may be adapted, for example single steps may be excluded and/or added and executed earlier or later than described. The method M2 starts with step S200 and proceeds to step S201 to detect if a disturbance 33 or 34 caused by a vehicle component is detected in the surround view. If not, the method steps back to S201 again.

Each kind of disturbance of the surround view may be detected by the control unit 3. The control unit 3 may detect whether the disturbance 33, 34 is caused by a component of the vehicle 1, such as the attachment 32 or the dual tires, or if the disturbance 33, 34 is caused by an object other than a component of the vehicle 1. The control unit 3 may process the image data provided by the first and second view 29, 30 and analyze all objects detected within the surround view. For example, the shapes of the vehicle components may be stored in the memory 27 of the control unit 3. The control unit 3 may compare all detected objects with the known shapes and distinguish an obstacle from a vehicle component if a detected object does not comply with a known shape of a vehicle component.

If the surround view is disturbed by a component of the vehicle 1 the part of the component being uncovered by the surround view is not detectable by the first or second position adjustable sensor 14 or 17 and may collide against an undetectable obstacle being also out of the surround view. Then, the method M2 proceeds to step S202 to reduce or to resolve the disturbance 33 or 34. Hence, the control unit 3 adjusts the position of the first and/or second position adjustable sensor 14 and 17 if a disturbance 33, 34 is detected to adapt the surround view for covering the vehicle 1 and its components completely. The control unit 3 may control each actuator of the extensions 15 and 18 to adjust the positions of each position adjustable sensor 14 and 17. The control unit 3 may move the first or the second position adjustable sensor 14 or 17 from a closer position to a position more distant from the longitudinal axis 2 to reduce the disturbance 33 or 34.

The method M2 proceeds to step S203 to check if the disturbance 33 or 34 is completely reduced (resolved). Thus, the control unit 3 checks at step S203 if the surround view is free of any interruption or any blind spot caused by any vehicle component.

If so, the disturbance 33 or 34 is reduced completely (resolved) and the method proceeds to step S205. Then, the control unit 3 may stop moving the first or the second position adjustable sensor 14 or 17 and the method ends.

If the surround view is not free of any interruption or any blind spot caused by any vehicle component, the disturbance 33 or 34 may still be reduced and the method proceeds to step S204 to check if an end stop of the first or second position adjustable sensor 14 or 17 is reached. If not, the method steps back to step S202 to continue reducing the disturbance 33 or 34. If an end stop of the first or second position adjustable sensor 14 or 17 is reached the corresponding position adjustable sensor can't be moved further and the method proceeds to step S205 to stop the method. Then, the disturbance 33 or 34 is reduced partly.

As can be seen in FIG. 6, the control unit 3 moved the first and second position adjustable sensor 14 and 17 laterally in respect of the longitudinal axis 2 away from the cabin 8 to extract the first and second position adjustable sensor 14 and 17. So, the distance 16 between the cabin 8 and the first position adjustable sensor 14 and the distance 19 between the cabin 8 and the second position adjustable sensor 17 were increased compared to FIG. 4 or FIG. 5. Consequently, each of the first view 28 provided by the first position adjustable sensor 14 and the second view 29 provided by the second position adjustable sensor 17 also shifted in a lateral direction away from the longitudinal axis 2. Thus, the overlapping area including the overlapping areas 30 and 31 was reduced while the surround view was enlarged. Since the surround view covers now all components of the vehicle 1 there is no interruption of the surround view caused by any vehicle component and the disturbance 33, 34 could be completely reduced or resolved.

As shown in FIG. 6, the markers 20 and 21 assigned to the first position adjustable sensor 14 and the markers 22 and 23 assigned to the second position adjustable sensor 17 are still detectable by their corresponding position adjustable sensors 14 and 17 since the markers 20 and 21 are within the first view 28 and the markers 22 and 23 are within the second view 29.

If the vehicle 1 shown in FIG. 6 is rebuilt as shown in FIG. 3 having wheels 4 to 7 configured as single tires and being decoupled from the attachment 32 the position adjustable sensors 14 and 17 may be positioned closer to the cabin 8 again to enlarge the overlapping area 30 at the front of the vehicle 1 and the overlapping area 31 at the rear of the vehicle 1. Thus, the control unit 3 is configured to move the first or the second position adjustable sensor 14 or 17 from a distant position to a position closer to the longitudinal axis 2 until a disturbance 33, 34 is detected. I. e., the control unit 3 controls each actuator of the extension 15 and 18 to adjust the positions of each position adjustable sensor 14 and 17 closer to the cabin 8. If a disturbance 33, 34 caused by a vehicle component is detected the position adjustable sensor 14 and 17 were moved too close to the cabin 8. Then, the control unit 3 reverses the direction of movement to increase the distances 16 and/or 19 again until all components of the vehicle 1 are covered by the surround view. If no disturbance 33, 34 caused by a vehicle component is detected when the position adjustable sensors 14 and 17 are retracted the control unit 3 stops the movement of the position adjustable sensors 14 and 17 if an end position is reached.

Each position adjustable sensor 14 and 17 may also comprise a global navigation satellite system (GNSS) receiver to determine each of their positions.

After a positional change of the first or the second position adjustable sensor 14 or 17 the corresponding position adjustable sensor 14, 17 may need to be (re-) calibrated. The calibration of the position adjustable sensor 14, 17 may comprise an adjustment of the orientation of the corresponding position adjustable sensor 14, 17, e. g. a rotational movement about a lateral and/or a vertical axis in respect of the longitudinal axis 2. A calibration may be needed for example if the position adjustable sensors 14 and 17 are extracted so far that one of the markers 20 and 21 got out of the first view 28 of the first position adjustable sensor 14 and/or one of the markers 22 and 23 got out of the second view 29 of the second position adjustable sensor 17. The control unit 3 is configured to calibrate the first and the second position adjustable sensor 14 and 17.

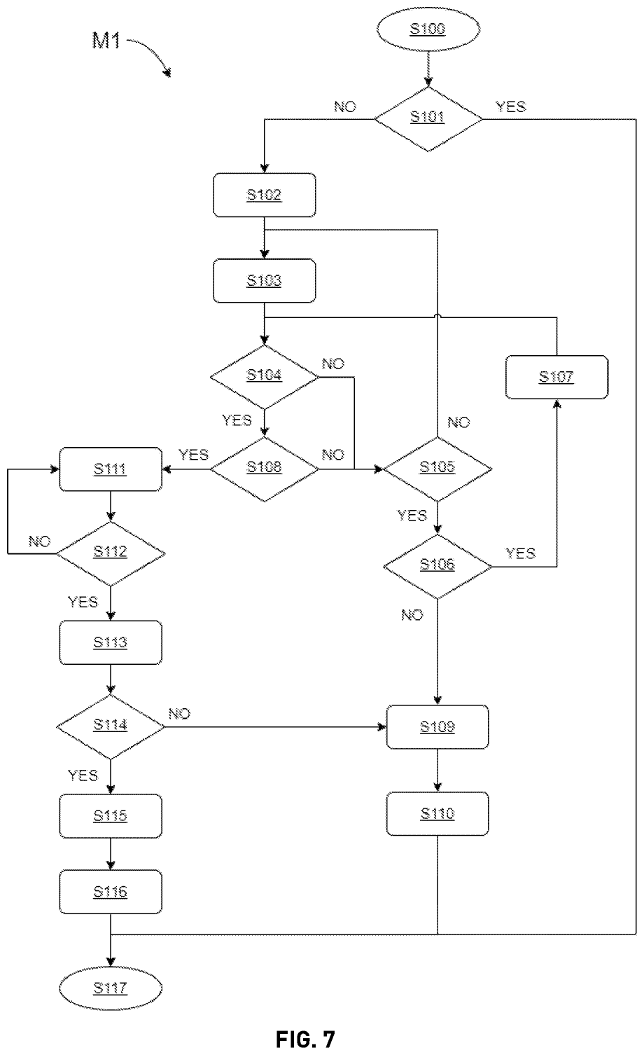

FIG. 7 shows another flow diagram for a method M1 to calibrate the sensor unit for environmental perception. The method M1 may be a computer-implemented method stored as a computer program product in the memory 27 of the control unit 3. The method may be carried out by the controller 26 of the control unit 3. The method M1 is described by way of example of several steps without any restriction in respect of that steps. I. e. the number or the order of steps may be adapted, for example single steps may be excluded and/or added and executed earlier or later than described. The method M1 may also be combined with the method M2.

The method M1 shown in FIG. 7 may start with step S100 each time when the position of a position adjustable sensor 14, 17 was adjusted (e. g. every time when method M2 finished). After step S100, the method proceeds to step S101. At step S101, the control unit 3 checks if a triangulation can be performed to determine the positions of the first and second position adjustable sensor 14 and 17. For example, the control unit 3 checks if each calibration vector from the reference point 24 to each marker 20 to 23 are within an expected tolerance range. If so, the first and second position adjustable sensors 14 and 17 are still calibrated well and the method may proceed to step S117 to stop the method. If not, at least one of the first and second position adjustable sensors 14 and 17 needs to be calibrated and the method proceeds to step S102.

At step S102, the control unit 3 determines the position adjustable sensor whose calibration vector exceeded the expected tolerance range and starts to calibrate this position adjustable sensor. The expected tolerance range may result from a previous calibration procedure and may be stored in the memory 27 of the control unit 3.

For the following description it is assumed that the position adjustable sensor 14 needs to be calibrated by way of example. For the case that the position adjustable sensor 17 needs to be calibrated the method can be applied analogously. For calibrating the position adjustable sensor 14 the control unit 3 manipulates the orientation of the position adjustable sensor 14 by controlling the corresponding actuator to rotate the position adjustable sensor 14 until the vehicle 1 is outside of the first view 28 of the position adjustable sensor 14. Then, the method proceeds to step S103.

At step S103, the control unit 3 controls the actuator to rotate the position adjustable sensor 14 in a reverse direction. The rotational movement may be performed stepwise with small rotation angles of about 0.2 degrees, for example.

The method proceeds to step S104 and the control unit 3 checks whether at least a component of the vehicle 1 can be detected by the position adjustable sensor 14.

If not, the method proceeds to step S105 and the control unit 3 checks if a rotational end stop is reached. If not, the method steps back to step S103 to continue the stepwise adjustment of the orientation of the position adjustable sensor 14. If a rotational end stop is reached at step S105, the method proceeds to step S106.

At step S106, the control unit 3 checks if the position adjustable sensor 14 can be retracted closer to the cabin 8. If so, the method proceeds to step S107 and the control unit 3 controls the actuator of the extension 15 to move the position adjustable sensor 14 closer to the cabin 8. Then, the method steps back to step S104 to check whether at least a component of the vehicle 1 can be detected by the position adjustable sensor 14.

If the position adjustable sensor 14 can't be retracted closer to the cabin 8 because an end stop is reached the method proceeds to step S109 explained in more detail later on.

If at least a component of the vehicle 1 can be detected by the position adjustable sensor 14 at step S104, the method proceeds to step S108.

At step S108 the control unit 3 checks whether all markers 20 and 21 assigned to the position adjustable sensor 14 can be detected by the position adjustable sensor 14. If not, the method proceeds to step S105 and proceeds as described above. If all markers 20 and 21 can be detected by the position adjustable sensor 14 a triangulation can be performed by the control unit 3.

Then, the method may proceed to the optional step S111 to brake the vehicle 1. The control unit 3 may send a message to an operator of the vehicle 1 to stop driving or may brake the vehicle 1 automatically. At the optional step S112, the control unit 3 may check whether the vehicle is at standstill and if a parking brake is applied. If not the method may step back to step S111 until the vehicle 1 is fully braked.

Then, the method proceeds to step S113. At step S113 the control unit 3 determines the new orientation and/or position of the position adjustable sensor 14 by means of triangulation based on the reference point 24 and the markers 20 and 21.

The method proceeds to step S114 and the control unit 3 checks if the triangulation could be performed successfully. If so, the method proceeds to step S115, if not, the method proceeds to step S109.

At step S115, the control unit 3 stores the results of the triangulation to its memory 27 to finish the calibration. The method may proceed to the optional step S116 and the control unit 3 may inform the operator of the vehicle 1 about the successful calibration process and the allowance to continue to drive the vehicle 1. The control unit 3 may optionally release the brake.

Then, the method proceeds to step S117 and the method ends.

If the method proceeded to step S109 due to an error the control unit 3 performs a diagnostic check to analyze the error. Then, the method proceeds to step S110 and the control unit 3 sends an error message to the operator of the vehicle 1 that the calibration of the position adjustable sensor 14 failed.

The method proceeds to step S117 and the method ends.

All references cited herein are incorporated herein in their entireties. If there is a conflict between definitions herein and in an incorporated reference, the definition herein shall control.

### LISTING OF DRAWING ELEMENTS

1 vehicle
2 longitudinal axis
3 control unit
4 wheel
5 wheel
6 wheel
7 wheel
8 cabin
9 hood
10 side mirror
11 mount
12 side mirror
13 mount
14 position adjustable sensor
15 extension
16 distance
17 position adjustable sensor
18 extension
19 distance
20 marker
21 marker
22 marker
23 marker
24 reference point
25 interface
26 controller
27 memory
28 first view
29 second view
30 overlapping area
31 overlapping area
32 attachment
33 disturbance
34 disturbance

1. A vehicle with a sensor unit for environmental perception, the sensor unit comprising
a first position adjustable sensor providing a first view of an environment; and
a second position adjustable sensor providing a second view of the environment;
the vehicle further comprising a control unit; wherein the control unit is configured
to provide a surround view of the environment by composing the first view and the second view;
to detect a disturbance in the surround view; and
to adjust the position of the first or the second position adjustable sensor for reducing the disturbance in the surround view.

2. The vehicle of claim 1, wherein the first view and the second view overlap in a first overlapping area at a front side of the vehicle or in a second overlapping area at a rear side of the vehicle.

3. The vehicle of claim 1, wherein the control unit is configured to detect that the disturbance is caused by a component of the vehicle.

4. The vehicle of claim 3, wherein the control unit is configured to distinguish the disturbance caused by the component of the vehicle from a disturbance caused by an object being different from the component of the vehicle.

5. The vehicle of claim 1, wherein the disturbance is an interruption of the surround view.

6. The vehicle of claim 1, wherein the disturbance is a blind spot in the surround view.

7. The vehicle of claim 1, wherein the first and the second position adjustable sensors are laterally moveable in respect of a longitudinal axis of the vehicle.

8. The vehicle of claim 7, wherein the control unit is configured to move the first or the second position adjustable sensor from a closer position to a position more distant from the longitudinal axis until the disturbance is resolved.

9. The vehicle of claim 7, wherein the control unit is configured to move the first or the second position adjustable sensor from a distant position to a position closer to the longitudinal axis of the vehicle, wherein the surround view is free of an interruption or a blind spot when the first or the second position adjustable sensor is positioned at the closer position.

10. The vehicle of claim 8, comprising at least one marker the marker being detectable by at least one of the first and the second position adjustable sensor when positioned at the distant position and when positioned at the closer position.

11. The vehicle of claim 1, comprising:
a first side mirror attached to the vehicle by a first mount; and
a second side mirror attached to the vehicle by a second mount; wherein the first position adjustable sensor is attached to the first side mirror or the first mount; and
the second position adjustable sensor is attached to the second side mirror or the second mount.

12. The vehicle of claim 11, wherein the first mount or the second mount is extendible.

13. The vehicle of claim 1, wherein the first or the second position adjustable sensor comprises a GNSS receiver.

14. The vehicle of claim 1, wherein the control unit is configured to carry out the method for calibrating a sensor unit for environmental perception according to any one of the claims.

15. A method for calibrating a sensor unit of a vehicle for environmental perception, the sensor unit comprising a first position adjustable sensor to provide a first view of an environment and a second position adjustable sensor to provide a second view of the environment for providing a surround view of the environment by composing the first view and the second view, the method comprising:
moving the first position adjustable sensor in a first direction until at least a part of a component of the vehicle is out of the first view of the environment;
moving the second position adjustable sensor in a second direction until at least a part of the vehicle is out of the second view of the environment; and
moving the first position adjustable sensor in a direction different to the first direction and moving the second position adjustable sensor in a direction different to the second direction until at least one marker of the vehicle is detectable by the first or the second position adjustable sensor.

16. The method for calibrating a sensor unit of claim 15, further comprising moving the first position adjustable sensor in a direction different to the first direction and moving the second position adjustable sensor in a direction different to the second direction until all components of the vehicle are covered by the surround view.

17. The method for calibrating a sensor unit of claim 15, further comprising determining the positions of the first and second position adjustable sensor by usage of triangulation.

18. The method for calibrating a sensor unit of claim 15, further comprising: braking the vehicle until at least one marker of the vehicle is detectable by the first or the second position adjustable sensor or until all components of the vehicle are covered by the surround view.
